(19) United States
(12) Patent Application Publication
(10) Pub. No.: US 2009/0200295 A1
(43) Pub. Date: Aug. 13, 2009

(54) MICROWAVE OVEN WITH A DRAIN ORIFICE

(75) Inventors: Gerard Beausse, Charenton (FR); Michel Georges Foray, Passenans (FR)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/911,551

(22) PCT Filed: Apr. 10, 2006
(86) PCT No.: PCT/US2006/013267

§ 371 Date: May 28, 2008

(30) Foreign Application Priority Data
Apr. 22, 2005 (FR) 0504053

(51) Int. Cl. H05B 6/80

(52) U.S. Cl. 219/733

(57) ABSTRACT

The microwave oven of the invention comprises a food-cooking cavity, microwave-generating means, a floor with a discharge orifice to which is removably fixed a protective strainer (11) comprising a circumferential base (15) for contact with the floor, characterised in that the base (15) of the strainer (11) comprises a plurality of spring-forming feet (19) which form anti-electric arc means (19).

Thus, the spring-forming feet (19) form anti-electric arc means (19), since their elasticity produces a spring effect which makes it possible to compensate for the irregularities of the contact surface on the floor, and to ensure good contact, hence preventing the formation of electric arcs.

The invention concerns the field of microwave ovens, in particular so-called large-scale professional catering ovens, that is, large-capacity ovens (typically over 0.15 m³).

In the fields of restaurants, canteens, refectories, etc., large-scale catering ovens are used.

There are several types of large-scale catering ovens. Convection-heated ovens comprise, inside the oven cavity, a gas burner or one or more heating resistors and one or more convection fans. In steam-heated ovens, the steam is produced either indirectly outside the cavity or directly by spraying water onto a fan associated with a heating resistor or a gas burner. Some ovens are the combination type, with convection and steam heating, to improve their performance.

The recent development of large-scale catering ovens has led to the integration, in addition to one or both heating means presented above, of a microwave heating means. International patent application WO 2004/032570, for example, has an oven with microwave heating means. In this oven, at least one microwave-generating means, in this case a magnetron, is provided outside the oven cavity, and supplies a microwave-agitating enclosure. This enclosure is opposite an opening in a side wall of the oven cavity, which is covered by a protective, microwave-permeable glass panel. In the cavity, opposite the microwave-agitating enclosure, is fixed a microwave adapter or coupling plate. Such a plate is better known by its English name “match plate”. In such microwave ovens, the use of metal inside the cavity is authorised.

An oven comprises, opening out on the floor at the level of an orifice, a discharge pipe or conduit the function of which is to allow discharge of the steam condensates, fat, water, etc. produced when the oven is used. The discharge orifice is typically protected by a protective grid or strainer. This protective drain strainer is generally metallic. The strainer is further kept fixed by a threaded shaft which is screwed onto a threaded rod projecting into the discharge conduit.

The circumference of the strainer is placed flat against the surface of the floor, at the periphery of the discharge orifice. However, if contact between these two elements is not perfect, the small distance between them combined with their potential difference may induce the formation of electric arcs. Such arcs cause a loss of energy of the microwaves, and hence a loss of output of the microwave heating means within the oven. They may further cause damage to components.

Several solutions may be envisaged. The prior-art drain strainers have a circumference having the largest possible surface area so that the area of contact with the floor is larger. However, this does not necessarily avoid poor contact. It is possible to increase the power of the microwave-generating means, to compensate for the loss of energy due to the electric arcs, or to increase the power of the other heating means, if any; however, a constant objective is to obtain a maximum output with minimum power. It may further be provided that the circumference of the strainer is welded to the periphery of the discharge orifice; it is, however, preferable that the strainer is mounted on its orifice removably, because it is desirable to be able to dismount it in order to clean any residues that may have built up in this place.

The present invention aims to make up for these drawbacks.

For this purpose, the invention concerns a microwave oven, comprising a food-cooking cavity, microwave-generating means, a floor with a discharge orifice to which is removably fixed a protective strainer comprising a circumferential base for contact with the floor, characterised in that the base of the strainer comprises a plurality of spring-forming feet which form anti-electric arc means.

Owing to the invention, the formation of electric arcs is avoided. In fact, the spring-forming feet form anti-electric arc means, since their elasticity produces a spring effect which makes it possible to compensate for the irregularities of the surface for contact with the floor, and to ensure good contact, hence preventing the formation of electric arcs. There are no electric arcs between the strainer feet because the same component is involved, which is therefore at the same potential.

Thus, surprisingly, to ensure better contact between the strainer and the floor, the invention consists of decreasing their area of contact, while maintaining sufficient contact to prevent the passage of microwaves. Thus the area of contact was decreased, not to avoid contact between the strainer and the floor as much as possible, but to favour it.

The invention applies to any microwave-heated oven comprising a discharge orifice. It applies particularly well to large-scale catering ovens.

The invention will be better understood with the aid of the following description of the preferred embodiment of the oven of the invention, with reference to the attached drawings in which:

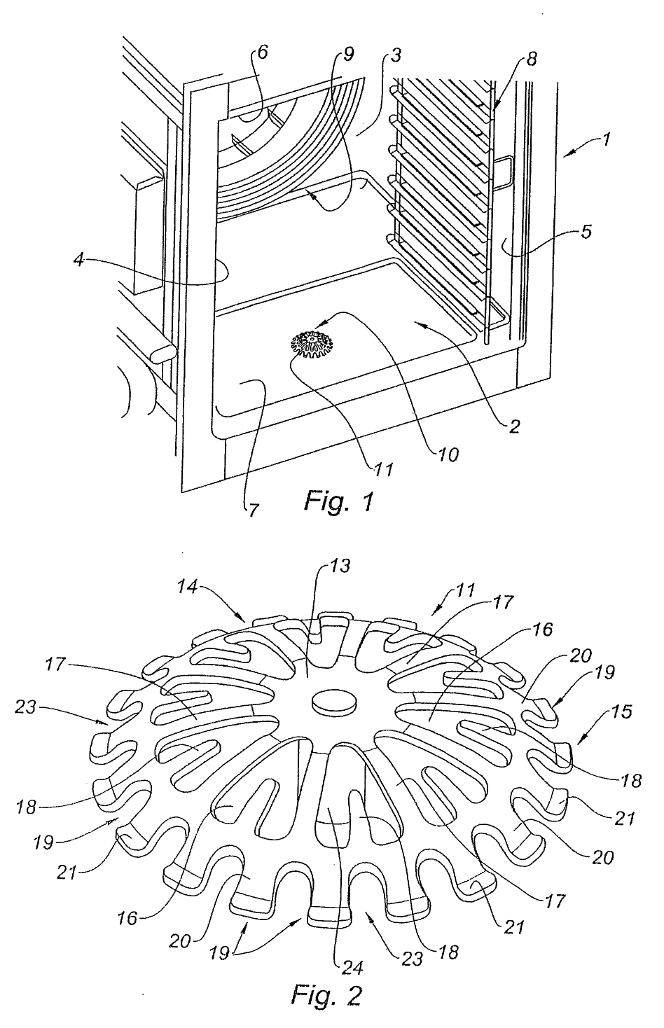

FIG. 1 shows a schematic perspective view of the preferred embodiment of the oven of the invention;

FIG. 2 shows a schematic perspective view from above of the preferred embodiment of the strainer of the oven of the invention;

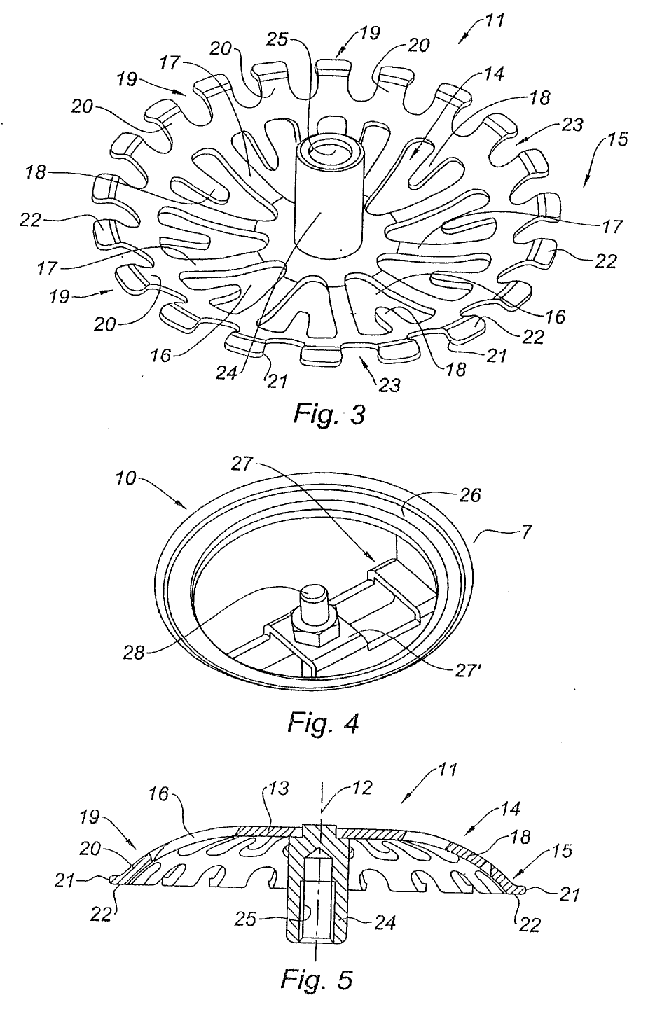

FIG. 3 shows a schematic perspective view from below of the preferred embodiment of the strainer of the oven of the invention;

FIG. 4 shows a schematic perspective view of the preferred embodiment of the discharge orifice of the oven of the invention; and

FIG. 5 shows a schematic view in profile section of the preferred embodiment of the strainer of the oven of the invention.

With reference to FIG. 1, the microwave oven 1 described here is a large-scale catering oven. It comprises a cooking or heating cavity 2 for foodstuffs. This cavity 2 is formed by a back wall 3 and two side walls 4, 5, a left wall 4 and a right wall 5 in a view from the front, as well as a roof 6 and a floor. 7, and opens towards the front. A door, not shown, is provided for closing the cavity 2 on its front face during operation of the oven 1. The cavity 2 here forms a volume of at least 0.15 m³. The oven comprises, on its side walls 4, 5, plate supports of which the right support 8 can be seen in FIG. 1. The plates are therefore guided and supported by these supports in the cavity 2, for the cooking of foodstuffs which are placed there, in a known manner.

The oven 1 is here a combination oven, comprising in this case steam heating means, not shown, convection heating means 9, and microwave-generating means, not shown. The steam heating means comprise an external boiler supplying the interior of the oven with steam, in a known manner. The convection heating means 9 here comprise a heating resistor combined with a convection fan, placed on the back wall 3 of the cavity 2; any other convection heating means may be envisaged, for example, a burner combined with a fan. The microwave-generating means here include three magnetrons fixed on the outside of the left wall 4 of the oven 1, each associated with cooling means comprising a fan and an air discharge conduit, well known to anyone skilled in the art. The magnetrons emit microwaves in waveguides, which open out into a microwave agitation enclosure. This wave agitation enclosure opens on to the cavity 2 of the oven 1 via an opening in the inner surface of the left wall 4 of the oven 1. This opening is covered by a protective, microwave-permeable glass panel. In the agitation enclosure is mounted a rotor for reflection and agitation of the microwaves, comprising adapted fins and blades, well known to anyone skilled in the art, an embodiment of which is precisely described in patent application WO 2004/032570. This rotor is driven by a motor placed outside the oven 1. These heating means will not be described below, because their structure and their operation are readily accessible to anyone skilled in the art. Furthermore, they may be as desired, and their structure is of no importance to the invention. What is important here is that microwave-generating means are provided in the cavity 2 of the oven 1.

The oven 1 comprises, opening out on its floor 7, at the level of an orifice 10 called a discharge orifice 10, a discharge conduit whose function is to allow discharge of the steam condensates, fat, water, etc. The discharge conduit is connected to any suitable discharge system. This type of discharge conduit is conventional and its structure will not be detailed. The discharge orifice 10 is protected by a protective drain strainer 11. This strainer 11 is here metallic.

The strainer 11 will be described in relation to its position when it is placed on the discharge orifice 10. Thus, the terms “top” or “above”, and “bottom” or “below”, mean respectively on the top side of the cavity and on the bottom side, that is, on the side of the discharge conduit. The floor 7 of the oven 1 extends in a horizontal plane. It will be noted that the strainer 11 appears, in FIG. 3, in a view from below, upside down.

With reference to FIGS. 2, 3 and 5, the strainer 11 is in the form of a convex disc, or dome, or teat, with symmetry of revolution about an axis 12. It comprises a crown 13 in the form of a generally planar plate extending in a horizontal plane. This crown 13 is extended by a connecting portion 14, of which the sectional shape is a curved arc, which extends downwards and ends in a peripheral base 15 for contact with the floor 7.

The crown 13 and/or the connecting portion 14 are apertured, so as to allow passage of various residues, steam condensates, fat, water, etc. In the particular case under consideration, the crown 13 comprises no apertures, while the connecting portion 14 comprises “V”-shaped apertures 16 of which the point is at the top, that is, towards the crown 13. These apertures 16, distributed regularly along the connecting portion 14, round the crown 13, thus form on the connecting portion 14 a plurality of connecting feet 17 between the crown 13 and the base 15, with, between these feet 17, return segments 18 from the base 15, of which the end is free. Any other configuration of the apertures 16 may be envisaged.

The base 15 of the strainer 11 comprises a plurality of peripheral feet 19. These feet 19 include an elongate portion 20 in extension of the connecting portion 14, and an end rim 21 having a horizontal bottom surface 22 designed to be in contact with the floor 7 of the oven 1, as will be seen later. The elongate portion 20 of each foot 19 has a certain elasticity. Each foot 19 is thus a spring-forming means 19.

The feet 19 are separated from each other by indentations 23. In the particular case under consideration, each indentation is in extension either of a connecting foot 17 or of a return segment 18 of the connecting portion 14. The spring-forming feet 19 are therefore in extension of a foot of a “V” of an aperture 16. In other words, the spring-forming feet 19 are offset angularly from the connecting feet 17, as well as from the return segments 18. This configuration is chosen for better distribution of forces and better control of the elasticity of the spring-forming feet 19. The indentations 23 and the feet 19 are here about the same circumferential width. In this case, the strainer 11 has twenty feet 19.

The strainer 11 comprises, projecting from its lower side, a shaft 24. This shaft 24 projects from the centre of the crown of the strainer 11, on its bottom surface, and extends along the axis 12 of revolution of the strainer 11. It comprises a bore 25, which is threaded, opening out at its bottom end.

With reference to FIG. 4, the discharge orifice 10 is surrounded, at its periphery, by a rim 26 slightly countersunk relative to the overall surface of the floor 7 at the centre of which the orifice 10 is formed. This rim 26 is arranged to be a contact support for the bottom surface 22 of the rims 21 of the spring-forming feet 19, and so serve as a support for the strainer 11, at the very least for its base 15.

Under the opening of the discharge orifice 10 is provided a support 27 for a threaded rod 28. This support 27 is in the form of a “U”-shaped arch 27 of which the two ends are fixed integrally under the surface of the floor 7, the centre bar—in this case apertured—extending horizontally under the opening of the orifice 10. The central portion 27′ of the arch 27 supports the threaded rod 28, which extends vertically through this central portion 27′. In this case, the central portion 27′ of the arch 27 has a bore for passage of the rod 28, which is fixed by a nut 29 to the top of this central portion 27′. The rod 28 in fact here extends from a component of the discharge conduit integral with the oven. During assembly of the oven 1, the arch 27 is mounted and fitted on the rod 28, then the nut 29 is screwed on to fix the whole. Above the nut, the threaded rod 28 projects in the direction of the opening of the discharge orifice 10, while remaining below the level of the rim 26 for supporting the base 15 of the strainer 11.

Whatever the chosen configuration, the important thing here is that a threaded rod 28, fixed relative to the oven 1, projects under the opening of the discharge orifice 10, preferably centred relative to the latter.

The strainer 11 is mounted on the discharge orifice 10 in the following manner: it is mounted above the orifice 10, with its threaded shaft 24 projecting at the bottom; this shaft 24 is moved in the direction of the threaded rod 28, which is introduced into the bore 25 of the shaft 24; the strainer 11 is screwed, by its threaded shaft 24, onto the threaded rod 28; at the end of screwing, the bottom surface 22 of the rims 21 of the spring-forming feet 19 come into contact with the rim 26 at the circumference of the discharge conduit 10.

The spring-forming feet 19 adapt by elasticity to the rim 26 of the discharge orifice 10, which makes it possible to compensate for any irregularities and hence obtain good contact of the bottom surface 22 of each rim 21 of the base 15 of the strainer 11.

Thus, when the oven 1 is running, and in particular when its microwave-generating means are activated, and therefore microwaves are propagated within the cavity 2 of the oven 1, this contact between the strainer 11 and the floor 7 avoids any formation of electric arcs. Furthermore, electric arcs do not form between the spring-forming feet 19 of the strainer 11, because it is the same component which is involved, which is therefore at the same potential; moreover, even if these feet 19 are relatively close to each other, the distance between them does not correspond to a “poor contact” distance, which would be smaller.

The spring-forming feet 19 are therefore, due to their elasticity and the contact which they favour between the base 15 of the strainer 11 and the floor 7 (here the rim 26 of the discharge orifice 10), anti-electric arc means 19.

Preferably, the axial dimensions of the threaded rod 28 and of the bore of the shaft 24 of the strainer 11 are determined so that, once the rims 21 of the spring-forming feet of the strainer 11 are in contact with the rim 26 of the discharge orifice 10, screwing can be continued in order to stress the spring-forming feet 19, that is, exert a force on these spring-forming feet 19, which also ensures better anchoring of the strainer 11 on the discharge orifice 10, and hence better contact between the bottom surfaces 22 of the rims 21 of the spring-forming feet 19 and the circumferential rim 26 of the discharge orifice 10. This stressing of the spring-forming feet 19 is possible due to their elasticity.

1. Microwave oven, comprising
a food-cooking cavity,
microwave-generating means,
a floor with a discharge orifice to which is removably fixed a protective strainer comprising a circumferential base for contact with the floor,
wherein the base of the strainer comprises a plurality of spring-forming feet which form anti-electric arc means.

2. Microwave oven according to claim 1, in which the oven comprises means for fixing the strainer arranged to cause stressing of the spring-forming feet.

3. Microwave oven according to claim 1, in which the strainer comprises a shaft for fixing to a rod integral with the oven, projecting into the discharge orifice.

4. Microwave oven according to claim 3, in which the shaft for fixing the strainer is threaded and the rod is threaded.

5. Microwave oven according to claim 3, in which the dimensions of the shaft of the strainer and of the rod are determined to allow screwing of the strainer causing stressing of the spring-forming feet.

6. Microwave oven according to claim 1, in which the spring-forming feet comprise, at their end, a rim for contact with the floor.

7. Microwave oven according to claim 6, in which the discharge orifice is surrounded by a rim for supporting the rims of the spring-forming feet.

8. Microwave oven according to claim 1, in which the strainer comprises a plate-like crown and “V”-shaped apertures forming connecting feet between the crown and the base of the strainer.

9. Microwave oven according to claim 8, in which the connecting feet are offset angularly from the spring-forming feet.

10. Microwave oven according to claim 1, which is a so-called “large-scale catering” oven.

11. A microwave oven, the oven comprising:
a cavity;
a microwave generator;
a floor comprising a discharge orifice; and
a protective strainer removably fixed to the floor, including a circumferential base for contact with the floor, the base having a plurality of spring-forming feet for inhibiting electric arc.
